(19) United States
(12) Patent Application Publication
(10) Pub. No.: US 2007/0272069 A1
(43) Pub. Date: Nov. 29, 2007

(54) VIBRATION PREVENTER FOR STRINGED INSTRUMENT

(76) Inventor: IL-YOUNG LEE, YONGIN-SI (KR)

Correspondence Address: IPLA P.A., 3580 WILSHIRE BLVD., 17TH FLOOR, LOS ANGELES, CA, 90010, US

(21) Appl. No.: 11/426,575

(22) Filed: Sep. 2, 2006

(30) Foreign Application Priority Data
May 25, 2006 (KR) 10-2006-0047187

(51) Int. Cl. G10D 3/00

(52) U.S. Cl. 84/293

(57) ABSTRACT

The present invention disclosed herein is a vibration preventer for a stringed instrument. According to the present invention, it is possible to prevent a voiced sound from unnecessary vibrations caused by transferring vibrations of plural strings of the stringed instrument. Accordingly, a quality of sound for the stringed instrument is converted to a clear sound, thereby obtaining a clear sound.

### CROSS-REFERENCE

This application claims priority to Korean Patent Application No. 10-2006-0047187, filed on May 25, 2006, in the Korean Intellectual Property Office, the disclosure of which is incorporated by reference herein.

### BACKGROUND OF THE INVENTION

1. Technical Field

The present disclosure relates to musical instruments. More particularly, the present disclosure relates to a vibration preventer for a stringed instrument capable of obtaining a clear sound by clearing a quality of sound for a stringed instrument and preventing a voiced sound from unnecessary vibrations caused by transferring vibrations of plural strings to strings of a headstock.

2. Discussion of the Related Art

In general, musical stringed instruments are kinds of musical instruments such as guitars, violins, cellos, violas and like.

These musical instruments, having structural configurations, comprise a body, a neck, and a headstock. The outside of the body is rounded. The neck is incorporated into the body and extended to the outside. The headstock is connected to an end of the neck and has several tunning pegs. Also, one end of a plurality of strings is fixed to the body and the other end thereof is arranged on the top of the body and connected to the tunning pegs of the headstock.

In a conventional stringed instrument, sound is emitted by bowing or striking the strings to press upon one or more strings of the stringed instrument with one or more fingers. In addition, because the body is comprised of resonance material, sound is produced through resonance phenomenon by the vibration of the strings.

FIG. 1 is a graph showing a vibration wave of strings for a conventional stringed instrument.

In FIG. 1, A section is a graph for showing the vibration of the strings between the body and the neck, and B section is a graph for showing the vibration of the strings that is generated from the headstock.

Referring to FIG. 1, while the stringed instrument is being played, sound is produced by the vibration of several strings. As shown in FIG. 1, the amplitude during A section where the vibration of the strings are generated is high, and then becomes dramatically decreased as time passed.

On the other hand, the amplitude during B section is low but becomes decreased. Accordingly, it is known that vibrations during A section are transferred to the headstock equivalent to B section, and thereby occurring continuous vibrations.

In this case, due to minute vibration interfering original tune, a minute vibration generated from the headstock while stringed instruments are being played interfere natural vibrations between the body and neck. Theses stringed instruments suffer from serious disadvantages. One disadvantage of such stringed instrument is that unnecessary sound occurs, and another disadvantage thereof is that sound becomes thick and unclear so that clear sound is not obtained.

To overcome these disadvantages, locking nut is employed at top end portions of the headstock or the body (or a fretboard). Theses locking nuts have been suggested in various configurations and methods. In particular, U.S. Pat. No. 4,517,874 discloses that an electric guitar is provided with a string clamping mechanism comprised of a planar base plate and one or more planar top members for clamping the strings between the base plate and top members. The clamp is secured to the guitar on an inclined surface between the top of the neck and the head of the guitar and is of shallow design to avoid interference with the playing of the guitar. A separate nut is provided which may be filed to achieve the desired string clearance at the first fret.

The above-mentioned similar structures are disclosed in U.S. Pat. Nos. 4,574,678, 4,579,033, 5,438,901, 5,932,822, and 6,723,905.

The locking nut performs a function to prevent tunning from being incorrect owing to chocking and tremolo arm by means of securing the length and the tension of strings of fretboard. In addition, it is possible to prevent vibrations of strings from being transferred to the headstock. However, it is considered that the function to prevent vibrations of strings from being transferred to the headstock is a little in itself acted as driving means. In the light of the structure, the locking nut is secured using screws through additional bores of the headstock. Therefore, the locking nut depends on the position of the bores of a truss rod groove that controls the curvature of the neck. In addition, it is difficult to install the locking nut, and the tension of the strings may be various. This problem is very important in the field of musical instruments. For instance, in case of guitars with the locking nut and headless guitars, e.g., a steinberger guitar, while chocking (pulling up sound) strings, the strings between the locking nut and bridge is extended, and at the same time, pitch is increased. In contrast, in case of guitars without the locking nut, e.g., a fender strato guitar, while chocking strings, the strings between the headmachine and bridge is extended, and at the same time, pitch is increased. Accordingly, since the extension range of the strings is wider than the guitars with the locking nut, there is an advantage while chocking strings. That is, in spite of securing tunning employing the locking nut, more finger force is required in chocking the strings.

### SUMMARY OF THE INVENTION

An exemplary embodiment of the present invention provides a vibration preventer capable of obtaining clear sound by preventing unnecessary vibrations caused by transferring vibrations of strings between a resonance body and a neck into strings arranged in a headstock.

An exemplary embodiment of the present invention provides a vibration preventer for stringed instrument attachable comfortably.

An exemplary embodiment of the present invention provides a vibration preventer for stringed instrument capable of maintaining the tension of strings irrespective of the position of a truss rod groove and can be secured to a headstock without screws.

An exemplary embodiment of the present invention provides a vibration preventer for stringed instrument that can be easily opened by a locking removal groove to be attachable comfortably.

In some embodiments of the present invention, a vibration preventer for a stringed instrument includes a resonance body, a neck extending from the resonance body, a headstock located at an front end of the neck and having tunning pegs, and a plurality of strings in which one end thereof is fixed to the resonance body, and the other end thereof is fixed to the headstock, the vibration preventer comprising: a pad unit contact with an outer surface of the strings to be located between a front end of the neck and the headstock for applying a clamping force to the strings, the pad unit preventing a voiced sound from unnecessary vibration caused by transferring a vibration of the strings generated from the resonance body and the neck to the headstock; and an incorporated supporting unit housing the pad unit and having a predetermined length and width to be mounted on the headstock.

In other embodiments of the present invention, the vibration preventer further comprises a hinge formed at one end of the supporting unit to be attachable to the headstock.

In further embodiments of the present invention, the pad unit comprises an upper pad unit contact with an upper surface of the string and a lower pad unit contact with a lower surface of the string. In this case, the upper and lower pad units are to be the thickness of preventing a vibration generated from the strings having different diameter.

In other embodiments of the present invention, the pad unit is made of one selected from the group consisting of a wool pad, a non-woven fabric, or a synthetic fabric.

In yet other embodiments of the present invention, the supporting unit comprises an upper supporting unit formed on an upper surface of the pad unit and having a projection tip that is protruded to outside of the one end of the pad unit and a lower supporting unit formed on a lower surface of the pad unit and having a fasten groove inserted into the pad unit so as to be locked/unlocked with the projection tip

In further embodiments of the present invention, the vibration preventer further comprises a locking removal groove disposed opposite to the projection tip in order that the upper supporting unit of the supporting unit is unlocked from the locked lower supporting unit.

In other embodiments of the present invention, the supporting unit is shaped like a horizontal plane or round to be mounted along a curvature of the headstock.

In further embodiments of the present invention, a lower surface of the supporting unit is apart from a skin surface of the headstock as far as a predetermined distance.

In yet other embodiments of the present invention, the vibration preventer intermediate between the tunning pegs located at the rear end of the headstock and a nut located at the front end of the neck.

### BRIEF DESCRIPTION OF THE DRAWINGS

The above and other features of the present invention will become readily apparent by describing in detail exemplary embodiments thereof with reference to the attached drawings in which:

FIG. 1 is a graph showing a vibration wave of strings for a conventional stringed instrument;

FIG. 2 shows a vibration preventer for a stringed instrument in accordance with one embodiment of the present invention;

FIG. 3 is a lateral view of the vibration preventer for the stringed instrument in accordance with the present invention;

FIG. 4 is a cross-sectional view taken along line A-A of FIG. 3;

FIG. 5 shows the vibration preventer for the stringed instrument in accordance with another embodiment of the present invention; and

FIG. 6 is a graph showing a waveform of strings in accordance with the present invention.

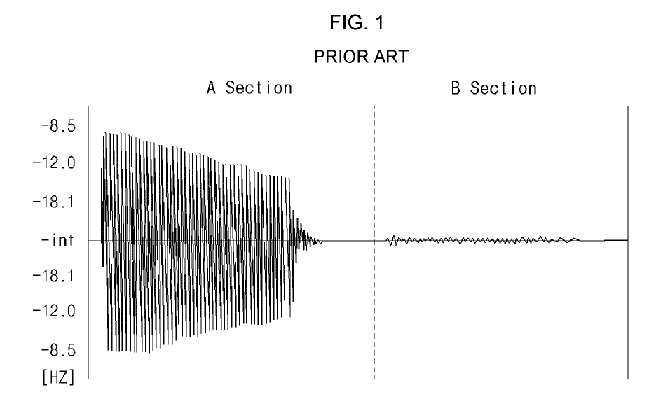

### DETAILED DESCRIPTION OF EXEMPLARY EMBODIMENTS

It will be understood that when an element or layer is referred to as being “on”, “connected to” or “coupled to” another element or layer, it can be directly on, connected or coupled to the other element or layer, or intervening elements or layers may be present.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, the exemplary embodiments of the present invention will be explained in detail with reference to the accompanying drawings.

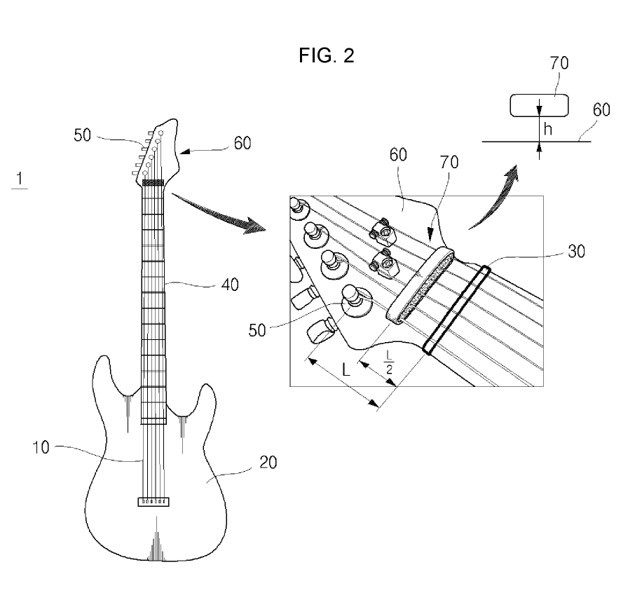

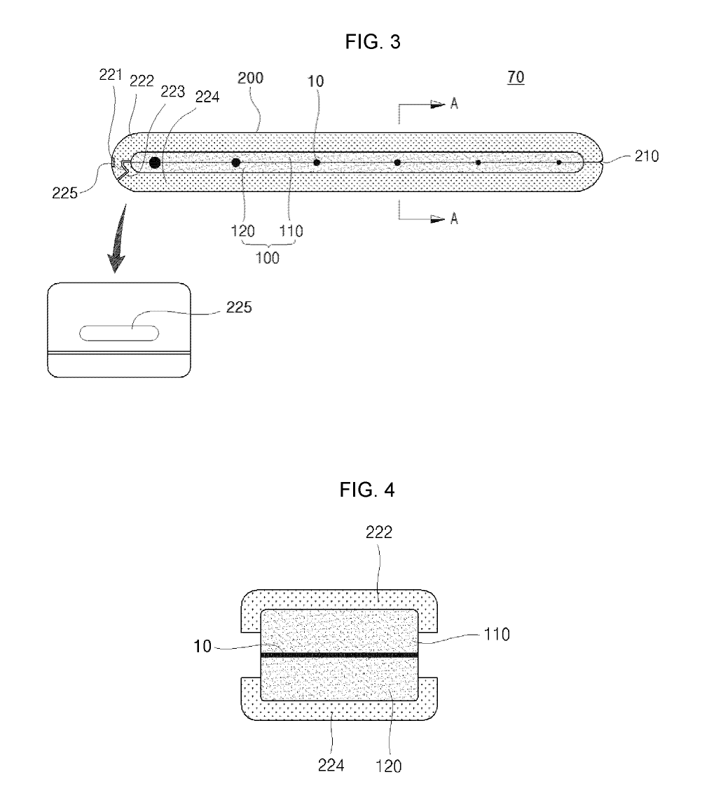

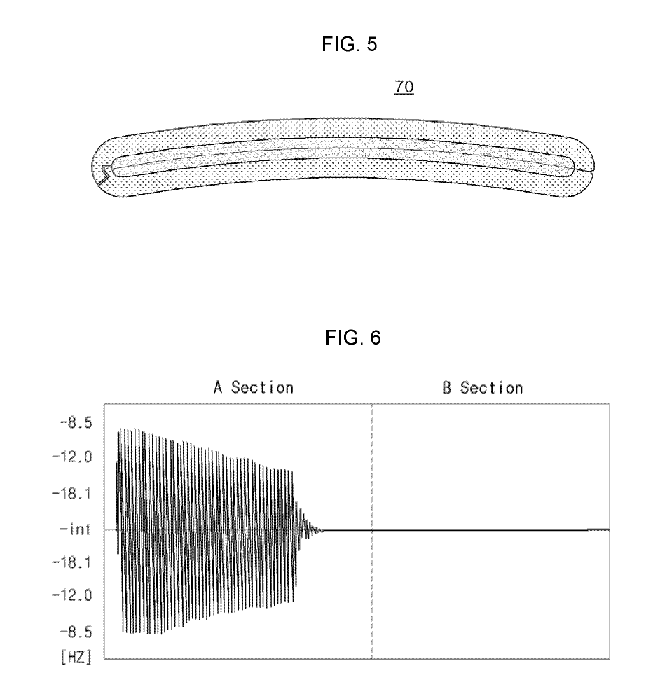

FIG. 2 shows a vibration preventer for a stringed instrument in accordance with one embodiment of the present invention. FIG. 3 is a lateral view of the vibration preventer for the stringed instrument in accordance with the present invention. FIG. 4 is a cross-sectional view taken along line A-A of FIG. 3. FIG. 5 shows the vibration preventer for the stringed instrument in accordance with another embodiment of the present invention.

Referring to FIGS. 2 and 3, a vibration preventer 70 for a stringed instrument may comprise a pad unit 100 and a supporting unit 200. The pad unit 100 is in contact with an outer surface of the strings 10 to be located between the front end of the neck 40 and the headstock 60 for applying a clamping force to the strings 10, and prevents a voiced sound from unnecessary vibration caused by transferring a vibration of the strings 10 generated from the resonance body 20 and the neck 40 to the headstock 60 of the stringed instrument 1.

The pad unit 100 includes an upper pad unit 110 contact with an upper surface of the string 10 and a lower pad unit 120 contact with a lower surface of the string 10. In this case, it is preferable that the upper and lower pad units 110 and 120 are to be the thickness of preventing a vibration generated from the strings having different diameter.

The pad unit 100 may be made of one selected from the group consisting of a wool pad, a non-woven fabric, or a synthetic fabric.

The vibration preventer 70 comprises an incorporated supporting unit 200 housing the pad unit 100 and having a predetermined length and width to be mounted on the headstock 60, and a hinge 210 formed at one end of the supporting unit 200 to be attachable to the headstock 60.

The supporting unit 200 comprises an upper supporting unit 222 formed on an upper surface of the pad unit 100 and having a projection tip 221 that is protruded to outside of the one end of the pad unit 100 and a lower supporting unit 224 formed on a lower surface of the pad unit 100 and having a fasten groove 223 inserted into the pad unit 100 so as to be locked/unlocked with the projection tip 221.

In order that the upper supporting unit 222 of the supporting unit 200 is unlocked from the lower supporting unit 224, a locking removal groove 225 is disposed opposite to the projection tip 221.

The supporting unit 200 is shaped like a horizontal plane or round to be mounted along a curvature of the headstock 60.

Preferably, a lower surface of the supporting unit 200 is apart from a skin surface of the headstock 60 as far as a predetermined distance. The reason for this is that if the lower surface of the supporting unit 200 is in contact with the skin surface of the headstock 60, there is a possibility that noise occur by interference of the headstock 60 due to vibrations of the strings 10 transferred to the vibration preventer 70 (See FIG. 2).

It is preferable that the vibration preventer 70 intermediate between the tunning pegs 50 located at the rear end of the headstock 60 and a nut 30 located at the front end of the neck 40.

The reason for this is that the extensive unnecessary vibration amplitude from the strings 10 of the headstock 60 may occur at the above-mentioned intermediate location.

It is clearly understood that the length and width of the vibration preventer 70 can be variously changed in accordance with a kind of stringed instruments by those skilled in the art.

Hereinafter, the vibration preventer for the stringed instrument according to the present invention will be described in detail referring to the accompanying drawings.

As shown in FIGS. 2 to 4, locked upper and lower supporting units 222 and 224 should be removed in order to install the vibration preventer 70 on the strings 10 between the tunning pegs and the nut 30.

One end of the upper supporting unit 222 is rounded downwardly. By means of the projection tip 221 formed at the end of the upper supporting unit 222, the one end of the supporting unit 224 is locked with the fasten groove 223 of the lower supporting unit 224. In order to remove this locked condition, the locking removal groove of the upper supporting unit 222 is lift up to rotate the upper supporting unit 222 to the outside at the center of the hinge 210 of the supporting unit 200.

Under the condition that the upper supporting unit 222 is rotated, a plurality of strings are located on the lower pad unit 120 of the lower supporting unit 224 by positioning the lower supporting unit 224 of the vibration preventer 70 below the strings 10 arranged on the headstock 60. Then, the projection tip 221 is locked with the fasten groove 223 formed at the lower supporting unit 224 by rotating the locking removal groove 225 at the center of the hinge 210 of the upper supporting unit 222.

The upper and lower supporting units 222 and 224 are locked together, and at the same time, the plurality of strings 10 arranged at the stringed instrument 1 are tightly located between the upper pad unit 110 and the lower pad unit 120.

The vibration preventer 70 according to the present invention is intermediate between the tunning peg (6^{th} tunning peg for 6 string guitar) located at the rear end of the tunning pegs 50 among several tunning pegs 50 of the headstock 60 and the nut 60.

Assuming that the length from the tunning pegs 50 at the rear end of the headstock 60 to the front end of the neck 40 is “L”, it is optimized that the vibration preventer 70 is located at L/2 position in order to prevent the vibrations of the strings 10 and optimize a quality of a sound for the stringed instrument.

Additionally, a distance between a lower surface of the supporting unit 200 and a skin surface of the headstock 60 is isolated as much as “h”, and thereby preventing noise caused by contacting with the skin surface of the headstock 60 due to the vibrations of the strings 10 generated from the body 20 and neck 40.

FIG. 4 is a cross-sectional view taken along line A-A of FIG. 3. Referring to FIG. 4, the strings 10 are tightly located between the upper pad unit 110 and the lower pad unit 120. The vibrations of the strings 10 are absorbed by the upper and lower pad units 110 and 120. As a result, it is possible to prevent the vibrations of the strings 10 arranged on the headstock 60.

For this reason, minute vibration preventing original tune of a stringed instrument is cut off, so that strings can be played in clear sound.

FIG. 5 shows the vibration preventer for the stringed instrument in accordance with another embodiment of the present invention.

Referring to FIG. 5, the shape of the vibration preventer 70 according to the present invention can be changed irrespective of various kinds of stringed instrument. As shown in FIG. 5, the vibration preventer 70 may be formed in upper-rounded shape.

As previously mentioned, the vibration preventer according to the present invention is applicable to various stringed instruments. Even if the vibrations generated from a plurality of strings are not transferred to the headstock, minute vibration interfering original tune is prevented to maintain clear original tune. As shown in FIG. 6, there are few vibrations during B section for the stringed instrument employing the vibration preventer according to the present invention.

In addition, the vibration preventer according to the present invention is independent of the position of a truss rod groove and can be secured to a headstock without screws. Also, the vibration preventer is easily installed on the stringed instrument and prevents the vibration of the strings in the headstock.

Unlike the locking nut, the vibration preventer does not influence tension variation of the strings.

Furthermore, the vibration preventer according to the present invention is easily opened by the locking removal groove to be comfortably attachable.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A vibration preventer for a stringed instrument including a resonance body, a neck extending from the resonance body, a headstock located at a front end of the neck and having tunning pegs, and a plurality of strings in which one end thereof is fixed to the resonance body, and the other end thereof is fixed to the headstock, the vibration preventer comprising:
a pad unit configured to be in contact with an outer surface of the strings to be located between a front end of the neck and the headstock for applying a clamping force to the strings, the pad unit configured to prevent a voiced sound from unnecessary vibration caused by transferring a vibration of the strings generated from the resonance body and the neck to the headstock; and
an incorporated supporting unit configured to house the pad unit and have a predetermined length and width to be mounted on the headstock.

2. The vibration preventer of claim 1, further comprising a hinge formed at one end of the supporting unit to be attachable to the headstock.

3. The vibration preventer of claim 1, wherein the pad unit comprises:
an upper pad unit configured to be in contact with an upper surface of the string; and
a lower pad unit configured to be in contact with a lower surface of the string,
wherein the upper and lower pad units are to be the thickness of preventing a vibration generated from the strings having different diameter.

4. The vibration preventer of claim 1, wherein the pad unit is made of one selected from the group consisting of a wool pad, a non-woven fabric, or a synthetic fabric.

5. The vibration preventer of claim 1, wherein the supporting unit comprises:
an upper supporting unit formed on an upper surface of the pad unit and having a projection tip that is protruded to outside of the one end of the pad unit; and
a lower supporting unit formed on a lower surface of the pad unit and having a fasten groove inserted into the pad unit so as to be locked/unlocked with the projection tip.

6. The vibration preventer of claim 5, further comprising a locking removal groove disposed opposite to the projection tip in order that the upper supporting unit of the supporting unit is unlocked from the locked lower supporting unit.

7. The vibration preventer of claim 1, wherein the supporting unit is shaped like a horizontal plane or round to be mounted along a curvature of the headstock.

8. The vibration preventer of claim 1, wherein a lower surface of the supporting unit is apart from a skin surface of the headstock as far as a predetermined distance.

9. The vibration preventer of claim 1, wherein the vibration preventer is intermediate between the tunning pegs located at the rear end of the headstock and a nut located at the front end of the neck.
